(19) United States
(12) Patent Application Publication
(10) Pub. No.: US 2008/0265183 A1
(43) Pub. Date: Oct. 30, 2008

(54) Method and Device for Handling a Container with Radioactive Material

(76) Inventor: Gerard Sirach, Hippolytushoef (NL)

Correspondence Address: Jerad G. Seurer;Mallinckrodt Inc., 675 McDonnell Blvd., P.O. Box 5840, St. Louis, MO, 63134, US

(21) Appl. No.: 12/090,127

(22) PCT Filed: Oct. 16, 2006
(86) PCT No.: PCT/US06/40539

§ 371 Date: Apr. 14, 2008

(30) Foreign Application Priority Data
Oct. 14, 2005 (EP) 05022433.6

(51) Int. Cl. G21F 5/00

(52) U.S. Cl. 250/506.1

(57) ABSTRACT

Embodiments of the present invention relate to reducing exposure to radiation while handling a radiopharmaceutical capsule. Specifically, in some embodiments, a substantially elongated handling device is disclosed that may be inserted into a radiation shielding enclosure that holds a radiopharmaceutical container having the radiopharmaceutical capsule disposed therein. The handling device may be connected to the radiopharmaceutical container, and the radiopharmaceutical container may then be removed from the radiation shielding enclosure via the handling device.

### FIELD OF THE INVENTION

The present invention relates generally to handling a radiopharmaceutical capsule that is/was stored in a radiopharmaceutical container.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

When handling containers that are filled with radioactive material, it may be desirable to take special care to avoid prolonged exposure to radiation being emitted from the radioactive material. For example, it may be desirable for care givers to avoid or limit exposure to vials containing capsules of iodine 131 when treating or preparing to treat patients with the iodine 131 for therapeutic purposes (e.g., in oncology). It should be noted that, when not being handled, the containers or vials of radioactive material are usually stored in radiation shielding enclosures, such as thick walled cylinders made of lead or tungsten and covered by a lid of the same material.

Sodium iodide-131 (Na¹³¹I), administered in the form of capsules, may be used to treat patients with thyroid diseases (e.g., hyperthyroidia and thyroid cancer). Numerous references in relevant literature link the administration of a well defined amount of I-131 radioactivity to the efficacy of such treatment and the absence of (major) side effects from such treatment. This defined amount may depend, for example, on the type of disease, the amount of radioactive iodine that is taken up by the thyroid during a diagnostic procedure preceding the actual administration, the age of the patient, the radiation dose that the physician wants to deliver, and so forth.

In order to achieve optimal patient care, it is important to measure the exact radioactive content of an I-131 capsule that is to be administered to the patient. This measurement may be performed in a suitable ionization chamber. However, the radioactivity of the capsules can be quite high. For example, capsules of 7.4 GBq (200 mCi) are sometimes measured and then administered to patients with metastasized thyroid cancer. Accordingly, the time that a capsule emitting this level of radioactivity is outside of its radiation shielded enclosure should be short to reduce exposure of the hospital staff to the radiation while handling the capsule. Moreover, to further reduce radiation exposure, the capsule should be kept at a sufficient distance from any person handling the material.

### SUMMARY

Certain aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention are directed to allowing radioactive material to be handled swiftly and securely, so as to minimize the time that the material is outside of a radiation shielding enclosure. Embodiments of the invention are further aimed at a manner of handling radioactive material that will ensure that the material is kept at a suitable distance from the hands of a handler.

A first aspect of the present invention is directed to a method of reducing exposure to radiation while handling a radiopharmaceutical capsule. In particular, a substantially elongated handling device is inserted into a radiation shielding enclosure that holds a radiopharmaceutical container while the radiopharmaceutical capsule is disposed in the container. The elongated handling device is then connected to the radiopharmaceutical container by maneuvering the handling device with respect to the container. For example, one quick and reliable way of forming a positive connection may include snapping the handling device onto the container. The radiopharmaceutical container is then removed from the radiation shielding enclosure via the handling device. One manner of allowing swift and easy release of the container from the handling device may include use of a release mechanism acting on a snap connecting member that is employed to provide a positive connection between the device and the container. In other words, an appropriate release mechanism could be utilized to disconnect the device from the container. Throughout this method, a sufficient distance is maintained between a user (e.g., a hand thereof) and the radiopharmaceutical container to limit exposure to radiation from the capsule therein.

Some may say that use of a handling device of the invention allows swift and efficient handling of radioactive material, thus limiting the time the material is outside a shielding enclosure. Some may say that use the elongated handling device enables a user to maintain a certain distance between the radioactive material and the user (e.g., a hand thereof) and/or provide radiation shielding, thus reducing the radiation exposure risk to individuals working with the radioactive material.

A second aspect of the invention is directed to a method of reducing exposure of a user to radiation while the user is handling a radiopharmaceutical capsule. In this method, the radiopharmaceutical capsule is removably supported at a distance from a handle of the elongated handling device. Further, the user is shielded from radiation emitted from the radiopharmaceutical capsule while the radiopharmaceutical capsule is being removably supported by the elongated handling device.

A third aspect of the invention is directed to a radiopharmaceutical handling device (e.g., for use in the methods described herein). The handling device includes an elongated body and a connecting tip arranged proximate a first end portion of the elongated body. This connecting tip may be coupled to a radiopharmaceutical container (e.g., that has a radiopharmaceutical capsule disposed therein). Further, the handling device includes a release mechanism arranged proximate a second end portion of the elongated body. This release mechanism is adjustably coupled to a release member that retractably engages the connecting tip of the device.

Yet a fourth aspect of the invention is directed to a device for handling a radiopharmaceutical capsule. This device includes an elongated body configured to distance a user from the radiopharmaceutical capsule. Additionally, the device includes a connecting tip arranged proximate a first end portion of the elongated body. This connecting tip is designed to releasably couple to a radiopharmaceutical container (e.g., that is configured to hold the radiopharmaceutical capsule therein). Further, the device includes a release mechanism arranged proximate a second end portion of the elongated body. This release mechanism is configured to manipulate a release member that is configured to bias the connecting tip of the device away from the radiopharmaceutical container.

Various refinements exist of the features noted above in relation to the various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE FIGURES

Various features, aspects, and advantages of the present invention will become better understood when the following detailed description is read with reference to the accompanying figures in which like characters represent like parts throughout the figures, wherein:

FIG. 1 is a perspective view of a two part cylindrical radiation shielding enclosure in which a radiopharmaceutical container holding a radiopharmaceutical is stored;

FIG. 2 is a cross-sectional view of the radiation shielding enclosure of FIG. 1 in an open configuration, wherein the radiopharmaceutical container is holding a radiopharmaceutical capsule;

FIG. 3 is a side elevation of the handling device coupled to the radiopharmaceutical container that is extracted from the radiation shielding enclosure;

FIG. 4 is an enlarged scale cross-sectional view of the tip portion of the handling device of FIG. 3 showing the connection and release mechanisms of the handling device;

FIG. 5 is a top view of the deforming release mechanism of FIG. 4;

FIG. 6 is a perspective top view of the tip portion of the handling device coupled to the radiopharmaceutical container;

FIG. 7 is a cross-sectional view of the body of the handling device;

FIGS. 8 and 9 are schematic cross-sectional views showing the rotating parts of the release mechanism in two extreme positions defining the retracted and extended position of the deforming member; and

FIG. 10 is an enlarged scale cross-sectional view of the tip portion of the handling device of FIG. 3 showing the radiopharmaceutical container being disconnected from the handling tool by deforming the snap connecting members.

### DETAILED DESCRIPTION OF SPECIFIC EMBODIMENTS

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

FIG. 3 is a side elevation of a handling device coupled to a radiopharmaceutical container which is extracted from a radiation shielding enclosure in accordance with an exemplary embodiment of the present invention. Specifically, FIG. 3 illustrates a handling device 1 for handling a radiopharmaceutical container 2 with a radiopharmaceutical capsule 3 disposed therein. The handling device 1 includes an elongated body 4 having a tip 5. In the illustrated embodiment, the body 4 includes a hollow tube accommodating various functional elements of the handling device 1. Further, a connecting mechanism 6 is arranged at or near the tip 5 of the elongated body 4 for releasably connecting the handling device 1 to the container 2. In the illustrated embodiment, this connecting mechanism 6 is arranged to establish a snap connection with the container 2 and includes a plurality of resiliently flexible snap connecting members 7, each having a guide surface 8 for engaging a protruding peripheral flange 9 of the container 2. It should be noted that the handling device 1 and/or the container 2 may include radiation shielding material (e.g., lead or plastic impregnated with lead).

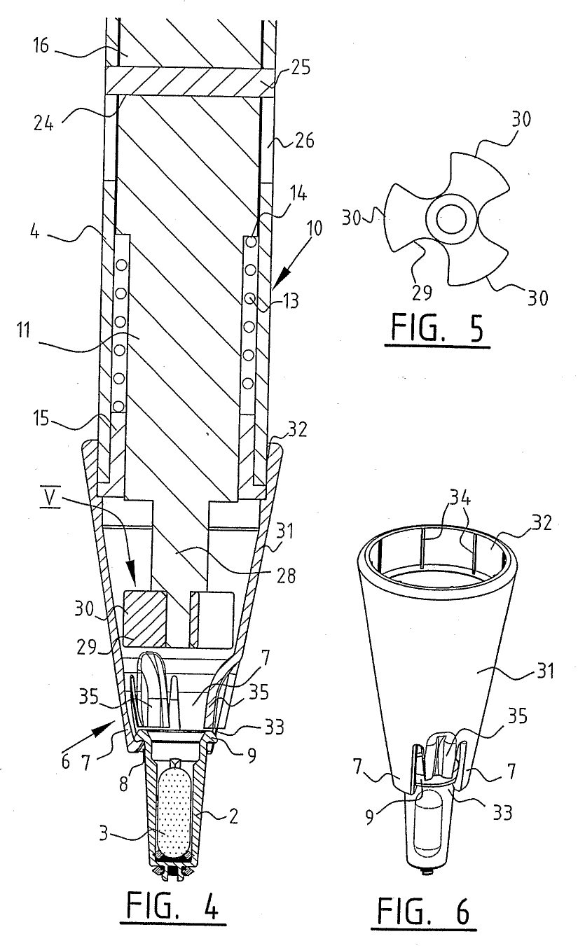

The handling device 1 may further include a release mechanism 10 acting on the connecting mechanism 6. Thus, the radiopharmaceutical capsule 3 in the container 3 may be removably supported. The term removably supported may be defined as supporting an object in a manner such that the object can be released or removed. For example, the radiopharmaceutical capsule 3 may be released from the handling device 1 and removed from the container 2. The release mechanism 10 may be configured to deform the snap connecting members 7 and hold them in their deformed states. To that end, the release mechanism 10 may include a deforming member 11 that is movably arranged in the body 4 and an operating mechanism 12 that operatively couples with the deforming member 11. The deforming member 11 may be slidable along an axis A of the body 4 between a retracted position of rest (FIG. 4) in which it does not deform the snap connecting members 7 and an extended release position (FIG. 10) in which it engages and deforms the snap connecting members 7 so as to disconnect the handling device 1 from the container 2. Further, the deforming member 11 may include a shaft having a plurality of engagement surfaces, each of which corresponds to a one of the snap connecting members 7.

In order to control release of the container 2, the handling device 1 further comprises a biasing mechanism 13 (e.g., a resilient component) for biasing the deforming member 11 to its retracted position of rest. In the illustrated embodiment the deforming member 11 has a stepped configuration defining a shoulder 14. The biasing mechanism 13 may include a compression spring arranged around a narrowed part of the deforming member 11 and held between the shoulder 14 and a locking ring 15, which also serves as a bearing, as illustrated in FIG. 4.

The operating mechanism 12 may be adapted to force the deforming member 11 to its extended release position against the action of the biasing mechanism 13. In order to avoid inadvertent operation of the handling device 1, the release mechanism 10 may be adapted for double-handed operation. To this end the operating mechanism 12 may include two rotating components 16, 17 that are arranged within the body 4. These rotating components 16, 17 may be mutually rotatable around the axis A and slidable along that same axis A. Additionally, the rotating components 16, 17 may have mutually engaging surfaces 18, 19 running at an angle to the axis A of the body 4 to facilitate axial extension based rotation of the rotating components 16, 17. Further, the rotating components 16, 17 may include coaxial bores 20, 21 accommodating a pin 22 about which the rotating components 16, 17 may rotate.

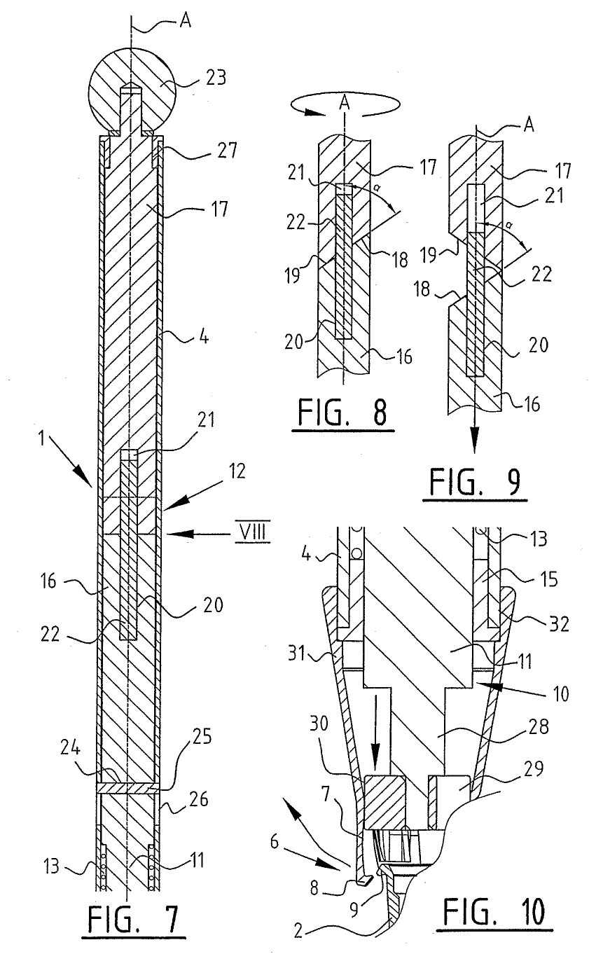

The rotating component 16, may be coupled to (e.g., integrally formed with) the deforming member 11, while the rotating component may be coupled to a turning knob 23 protruding from the body 4. In the illustrated embodiment, the rotating component 17 carrying the knob 23 is rotatably arranged within the body 4 and held therein by a locking ring 27 surrounding a narrowed end of the rotating component 17. The locking ring 27 may also serve as a bearing for the rotating component 17 (FIG. 7). The rotating component 16 carrying the deforming member 11 may be slidably arranged in the body 4. In order to prevent rotating component 16 from rotating within the body 4, it may have a transverse bore 24 into which an anti-rotation pin 25 may be inserted. This anti-rotation pin 25 may be slidably received in longitudinal slots 26 formed in body 4.

In the illustrated embodiment the deforming member 11 has a shaft 28 carrying a propellor shaped deforming element 29 having a number of engagement surfaces 30, each corresponding to one of the snap connecting members 7. Thus, when moving the deforming member 11 to its extended position through use of the operating mechanism 12, the engagement surfaces 30 may contact the insides of the snap connecting members 7, bending these outward to disengage from the flange or ridge 9 of the radiopharmaceutical container 2 (FIG. 10).

In the illustrated embodiment of the handling device 1, the tip 5 may be formed by a disposable hollow tip part 31 that is releasably connected to the body 4. The tip 5 may be disposable and releasably connected to the body 4 to facilitate replacement when the tip wears from repeated sue and so forth. This tip part 31 is tapered, having a relatively wide opening 32, and a relatively narrow opening 33. The narrow opening 33 may be defined by the free ends of the snap connecting members 7. The wide opening 32 may be arranged such that it can be slid and clamped around the end of the body 4 from which the deforming member 11 protrudes. Further, the wide opening 32 may be provided with inwardly protruding resilient ridges 34 that facilitate a tight fit while allowing the tip part 31 to be released from the body 4 without requiring excessive force. Inwardly extending supports 35 may be arranged between each of the snap connecting members 7 to limit the movement of the container 2 when connected to the tip part 31.

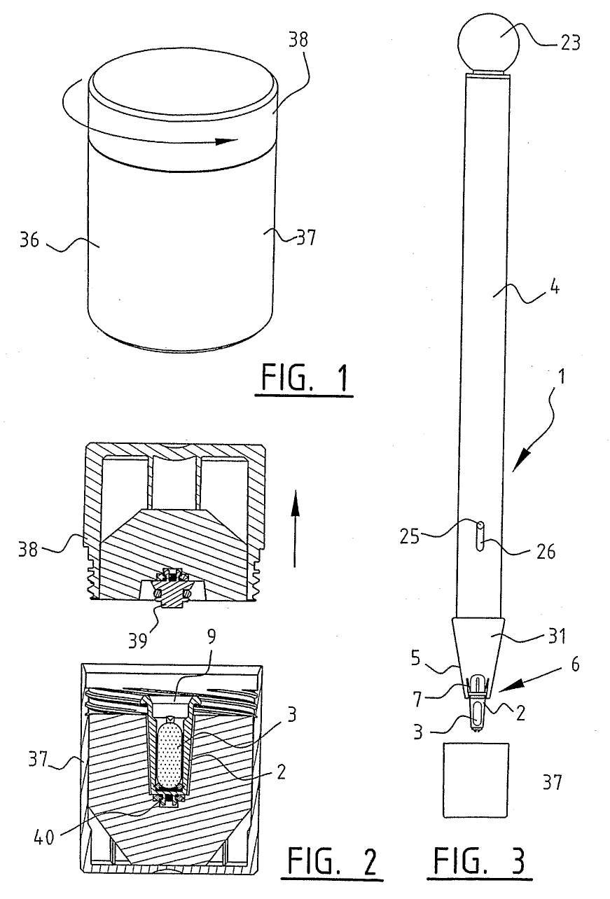

Using the handling device 1 described above, the container 2 may be handled while it contains the radiopharmaceutical capsule 3. For example, the container 2 may be removed from a radiation shielding enclosure 36 using the handling device 1. First, the radiation shielding enclosure 36, which may consist of a body 37 and a lid 38, may be opened by unscrewing the lid 38 from the body 37 (FIG. 1). Because the lid 38 carries a plug-type lid 39, which operates to seal or close the container 2, unscrewing the lid 38 may essentially simultaneously lead to the container 2 being opened (FIG. 2). The container 2 may be arranged in the body 37 of the radiation shielding enclosure with its flange 9 protruding from the body 37, thus enabling the handling device 1 to readily couple with the container 2. After the lid 38 and plug-type lid 39 are removed, the handling device 1 may be inserted into the radiation shielding enclosure 36 and connected to the container 2 via the snap connecting members 7, which may engage the flange 9. To engage the flange 9, the snap connecting members 7 may be bent outward as the handling device 1 is lowered onto the container 2 and the guide surfaces 8 are slid along the sloping edge of the container flange 9. Eventually, the guide surfaces 8 may be forced to slide over the flange 9 and then will flex back to establish an interlocking engagement with the flange 9 (FIG. 4).

After the handling device 1 has been connected to the container 2, the container 2 may be removed from the radiation shielding enclosure 36 with the handling device 1 by pulling it from the enclosure body 37, thus releasing a snap connection 40 between the container 2 and the enclosure body 37 (FIG. 3). The container 2 may then be ready for transportation and/or handling. For example, the container 2 may be ready for insertion into a well-type ionization chamber for measuring the radioactive content of the capsule 3. In another example, the container 2 may be ready to facilitate ingestion of the capsule 3 by a patient. It should be noted that, in some embodiments, the handling device 1 and the container 2 include radiation shielding material, thus reducing the potential for exposing a user to radiation from within the container 2 during transport. In certain embodiments, the handling device 1 may cover the container 2 with radiation shielding material while in a connected position with the handling device 1. In other words, the interface between the handling device 1 and the container 2 may serve as a radiation shielding cover for the open end of the container 2.

If it is desirable to measure the radioactive content of the capsule 3, the container 2 holding the capsule 3 may be inserted into the ionization chamber using the handling device 1. After insertion, the ionization chamber may be activated to measure the radioactivity of the material (e.g., the capsule 3) in the container 2. Since the ionization chamber is well-shaped, the elongated handling device 1 may have no discernible effect on the radioactivity measurement. After the desired information is obtained, the container 2 may be withdrawn from the ionization chamber with the handling device 1 and returned to its radiation shielding container 36, where it may be pressed into the body 37 again, thus re-establishing the snap connection 40.

After replacing the container 2 in the body 37, it may be released from the handling device 1 using the operating mechanism 12. To achieve this release via the operating means 12, the user may hold the body 4 of the handling device 1 in one hand and the knob 23 in the other hand. The operating mechanism 12 may be adjustably coupled to a release member that retractably engages the snap connecting members 7. The term “adjustably coupled” may be defined as a coupling between two or more components such that manipulation of one component facilitates adjustment of another component. The term “retractably engaged” may be defined as an arrangement of components such that one component may be engaged with a second component or retracted from the engagement. By turning the knob 23 relative to the body 4, using both hands, the parts 16, 17 may be rotated with respect to each other. Due to the angled surfaces 18, 19 engaging each other, the parts 16, 17 may be forced apart, as shown in FIGS. 8 and 9. In this way the deforming member 11 may be extended, thus compressing the biasing spring 13 and bending the snap connecting members 7 outward so as to disconnect the container 2 from the handling device 1. When a user releases his grip on the handling device 1, the biasing spring 13 may force the deforming member 11 back to its retracted position, thus rotating the parts 16, 17, and consequently also rotating the body 4 and knob 23 back to their initial positions.

If it is desirable for a patient to ingest the capsule 3, after the handling device 1 has been disconnected from the container 2, a patient may take the body 37 holding the open container 2 and put it to his lips to swallow the capsule 3. In some embodiments, the lid 38 may first be screwed back onto the body 37, thus simultaneously closing the radiation shielding enclosure 36 and the container 2. The enclosure 36 may then be temporarily stored until the patient is ready to swallow the radioactive material 3, or it may be transported to a location where the patient is waiting for the radioactive material 3. Further, in some embodiments, the handling device 1 may be utilized to transfer the container 2 and the capsule 3 to a more convenient device for allowing the patient to ingest the capsule 3.

When introducing elements of the present invention or various embodiments thereof, the articles “a”, “an”, “the”, and “said” are intended to mean that there are one or more of the elements. The terms “comprising”, “including”, and “having” are intended to be inclusive and mean that there may be additional elements other than the listed elements. Moreover, the use of “top”, “bottom”, “above”, “below” and variations of these terms is made for convenience, but does not require any particular orientation of the components.

While the invention may be susceptible to various modifications and alternative forms, specific embodiments have been shown by way of example in the figures and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method of reducing exposure to radiation while handling a radiopharmaceutical capsule, comprising:
inserting a substantially elongated handling device into a radiation shielding enclosure that contains a radiopharmaceutical container, the radiopharmaceutical container having the radiopharmaceutical capsule disposed therein;
connecting the handling device to the radiopharmaceutical container; and
removing the radiopharmaceutical container from the radiation shielding enclosure via the handling device, wherein the inserting, connecting, and removing comprise maintaining at least a minimum predetermined distance between a user of the device and the radiopharmaceutical container.

2. The method of claim 1, comprising disposing the radiopharmaceutical container into a test chamber and measuring radioactive content of the radiopharmaceutical capsule.

3. The method of claim 1, comprising returning the radiopharmaceutical container into the radiation shielding enclosure via the handling device, and disconnecting the handling device from the radiopharmaceutical container.

4. The method of claim 1, wherein the connecting comprises covering the radiopharmaceutical capsule with shielding material, wherein the covering comprises blocking radiation emitted from the radiopharmaceutical capsule.

5. The method of claim 1, wherein the connecting comprises covering an open portion of the radiopharmaceutical container with a radiation shielded portion of the handling device.

6. The method of claim 1, comprising administering the radiopharmaceutical capsule to a patient.

7. The method of claim 1, wherein the connecting comprises snapping a snap connecting member of the handling device onto a mating member of the radiopharmaceutical container.

8. The method of claim 7, comprising unsnapping the snap connecting member from the mating member and separating the handling device from the radiopharmaceutical container.

9. The method of claim 7, comprising actuating the snap connecting member by rotating at least one rotatable member about an axis and causing another member to extend along the axis toward the snap connecting member.

10. A method of reducing exposure of a user to radiation while the user is handling a radiopharmaceutical capsule, comprising:
removably supporting the radiopharmaceutical capsule at a distance from a handle of the elongated handling device; and
shielding radiation emitted from the radiopharmaceutical capsule during the removably supporting.

11. The method of claim 10, wherein removably supporting the radiopharmaceutical capsule comprises receiving a radiopharmaceutical container having the radiopharmaceutical capsule into engagement with an attachment mechanism of the elongated handling device.

12. The method of claim 11, comprising coupling the handling device to the radiopharmaceutical container by snap fitting a snap connecting member around a mating member of the radiopharmaceutical container.

13. The method of claim 12, comprising deforming the snap connecting member to disengage the handling device from the radiopharmaceutical container.

14. The method of claim 11, wherein the shielding comprises blocking radiation at an interface between the attachment mechanism and the radiopharmaceutical container.

15. The method of claim 10, comprising covering the radiopharmaceutical capsule with shielding material during removably supporting the radiopharmaceutical capsule.

16. A device for handling a radiopharmaceutical capsule, comprising:
an elongated body;
a connecting tip arranged proximate a first end portion of the elongated body, the connecting tip coupled to a radiopharmaceutical container, wherein the radiopharmaceutical container includes the radiopharmaceutical capsule disposed therein; and
a release mechanism arranged proximate a second end portion of the elongated body, the release mechanism adjustably coupled to a release member that retractably engages the connecting tip.

17. The device of claim 16, wherein the elongated body comprises radiation shielding material.

18. The device of claim 16, wherein the radiopharmaceutical container comprises radiation shielding material.

19. The device of claim 16, wherein the connecting tip comprises a snap connecting member engaged with a mating member of the radiopharmaceutical container.

20. A device for handling a radiopharmaceutical capsule, comprising:
an elongated body configured to distance a user from the radiopharmaceutical capsule;
a connecting tip arranged proximate a first end portion of the elongated body, the connecting tip configured to couple to a radiopharmaceutical container that is configured to hold the radiopharmaceutical capsule therein; and
a release mechanism arranged proximate a second end portion of the elongated body, the release mechanism configured to manipulate a release member that is configured to bias the connecting tip away from the radiopharmaceutical container.

21. The device of claim 20, wherein the elongated body comprises radiation shielding material.

22. The device of claim 20, wherein the connecting tip comprises a snap connecting member configured to engage a mating member.

23. The device of claim 20, wherein the connecting tip is configured to extend about a mating portion of the radiopharmaceutical container.
